(19) United States
(12) Patent Application Publication
(10) Pub. No.: US 2019/0110656 A1
(43) Pub. Date: Apr. 18, 2019

(54) Brushing Device

(71) Applicant: Ewbank Products Ltd, Congleton (GB)

(72) Inventor: Krishnan Srirangam, Chicago, IL (US)

(21) Appl. No.: 16/158,029

(22) Filed: Oct. 11, 2018

(30) Foreign Application Priority Data
Oct. 13, 2017 (GB) 1716840.2

(51) Int. Cl. A47L 11/40; A47L 11/22; A47L 11/24; A46B 5/00; A46B 13/00; A46B 13/02; A46B 7/02; B25G 1/04

(52) U.S. Cl. CPC A47L 11/4013; A46B 2200/3033; A47L 11/24; A47L 11/4005; A47L 11/4041; A47L 11/4069; A47L 11/4075; A46B 5/0008; A46B 13/006; A46B 13/02; A46B 5/0054; A46B 7/023; B25G 1/04; A46B 2200/302; A47L 11/22

(57) ABSTRACT

A brushing device comprises a handle 1 with a brush head 2 at its lower, in use, end. The carrier carries a broom brush 3, which is extensible for sweeping dust, and a rotating brush 4 for picking up swept dust for delivery to a dust receptacle 47. The carrier 2 is a three piece injection moulding, comprised of a front cover 5, a back cover 6 and a central moulding 7. The covers are connected to the central moulding and the each other by conveniently positioned screws in integrally moulded screw bosses that do not need to be separately described, but at least some of which can be seen on the drawings. The central moulding has an upwardly open void 8 between a pair of upwardly extend, converging fingers 9, which engage in slots 10 in a tubular part 11 of a broom brush extender 12.

### CROSS REFERENCE TO RELATED APPLICATION

This application claims priority to and takes the benefit of Great Britain Patent Application No. 1716840.2 filed on Oct. 13, 2017, the contents of which are herein incorporated by reference.

### BACKGROUND OF THE INVENTION

### Field of the Invention

The present invention relates to a brushing device for brushing and picking up dirt.

### Description of the Related Art

Brooms and both powered and unpowered (push operated) sweepers are well known. Sweepers have limitations in their effectiveness, for instance around the edges and in the corners of floors. Brooms usually need complementing with a dustpan and brush for picking up brushed up dirt.

### SUMMARY OF THE INVENTION

The object of the present invention is to provide an improved brushing device for brushing and picking up dust or dirt.

According to the invention there is provided a brushing device for brushing and picking up dirt, comprising:
a handle and
a brush head attached to the handle in use and carrying:
   a broom brush for sweeping up dust,
   a rotatable brush for picking up swept dust,
   a motor for driving the rotatable brush and
   a dust receptacle for receiving picked up dust.

The broom brush can be permanently exposed, at least at one side, for sweeping use. However, preferably the broom brush is arranged to be withdrawn with respect to and preferably into the brush head. This allows the broom brush, or at least its bristles, to be more effective in brushing and to be withdrawn after use, allowing the rotatable brush to reach the dirt. For extension and withdrawal of the broom brush, it is preferably connected to a grip movable axially of the handle. In the preferred embodiment, the grip is a collar provided around a socket for the handle.

Whilst the broom brush—or at least its bristles—can remain exposed, even when withdrawn; in the preferred embodiment, the bristles of the broom brush are accommodated within the brush head when withdrawn. For this, in the preferred embodiment, the brush head has a central partition and a front cover held spaced apart from each other for accommodating the broom brush.

In the nature of the device, with the rotatable brush being arranged to engage the dirt on a floor for instance, it is likely that the dirt receptacle will be above the rotatable brush. It is envisaged that it may be possible to project the dirt from the rotating brush against the broom brush for direction into the receptacle. However in the preferred embodiment, where the central partition is provided, this can be arranged to isolate the broom brush from the rotating brush, with the dirt being projected up the central partition to the receptacle. Conveniently the central partition has an over-hang for turning the dirt path to fall into the receptacle.

For assisting the upwards direction of the dirt, a lower portion of the central partition can be curved complementarily with an axis of rotation of the rotating brush. Further an opposite side of a dirt path can also be curved. This opposite side is conveniently provided on the receptacle.

### BRIEF DESCRIPTION OF THE SEVERAL DRAWINGS

To help understanding of the invention, a specific embodiment thereof will now be described by way of example and with reference to the accompanying drawings, in which:

FIG. 1 is a front view of a brushing device in accordance with the invention, with a broom brush withdrawn;

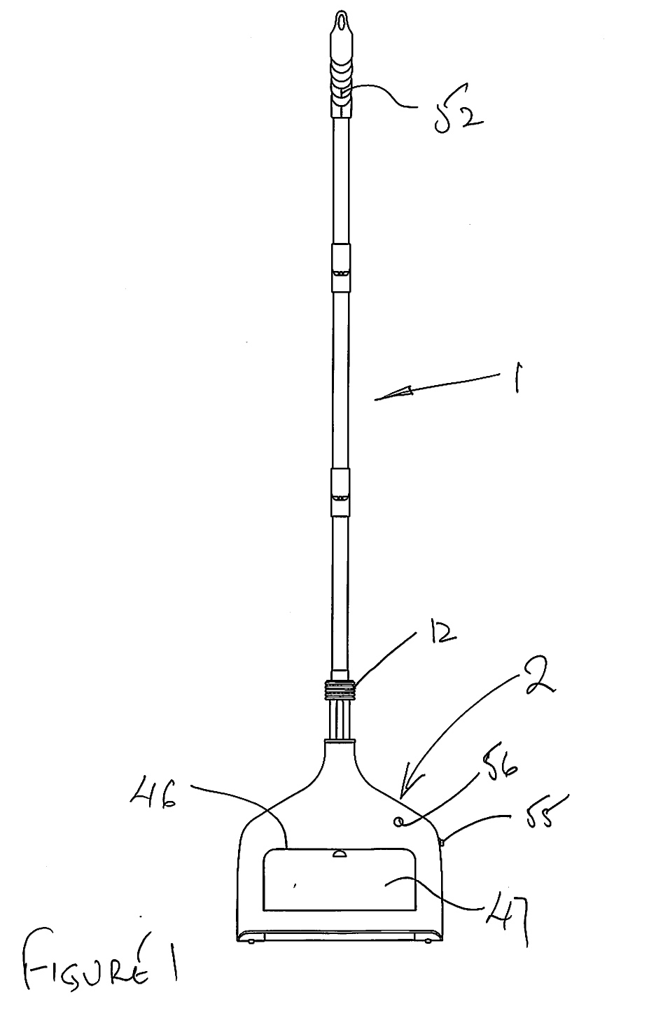

FIG. 2 is a back view of the device of FIG. 1 with the broom brush extended;

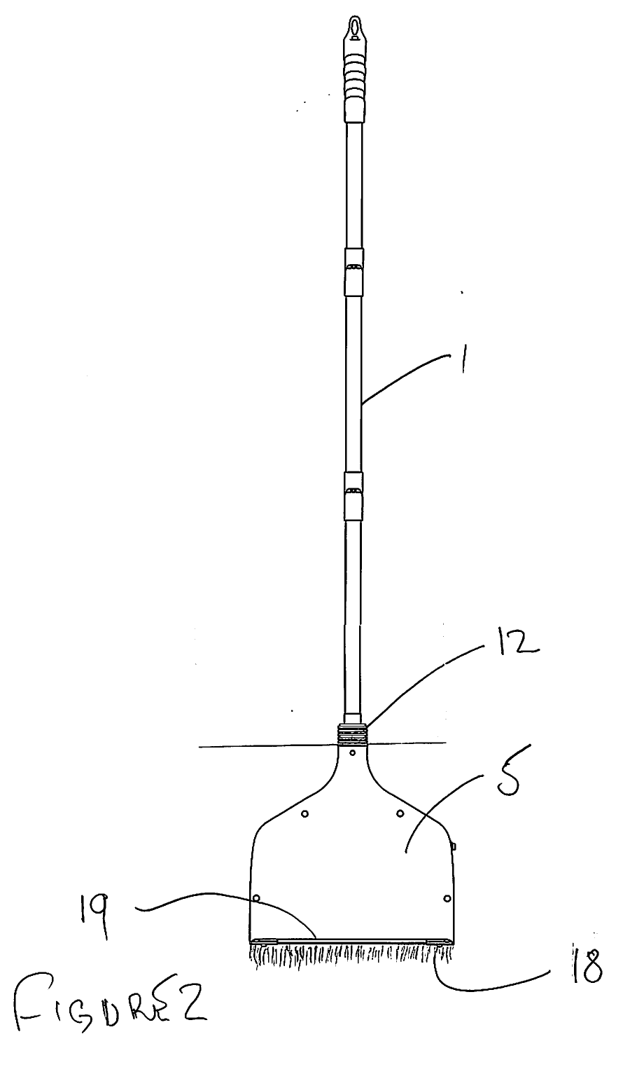

FIG. 3 is another back view of the brushing device of FIG. 1, on a bigger scale showing in particular a brush head of the device, with the broom brush withdrawn;

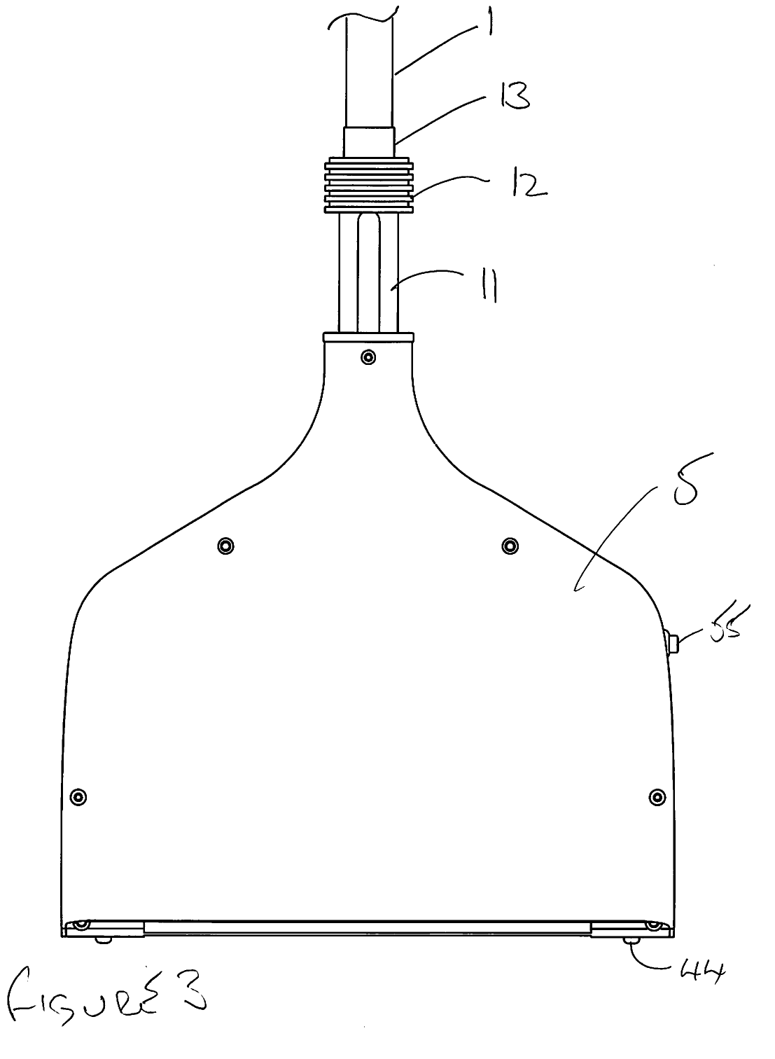

FIG. 4 is a side view of the brush head of FIG. 3;

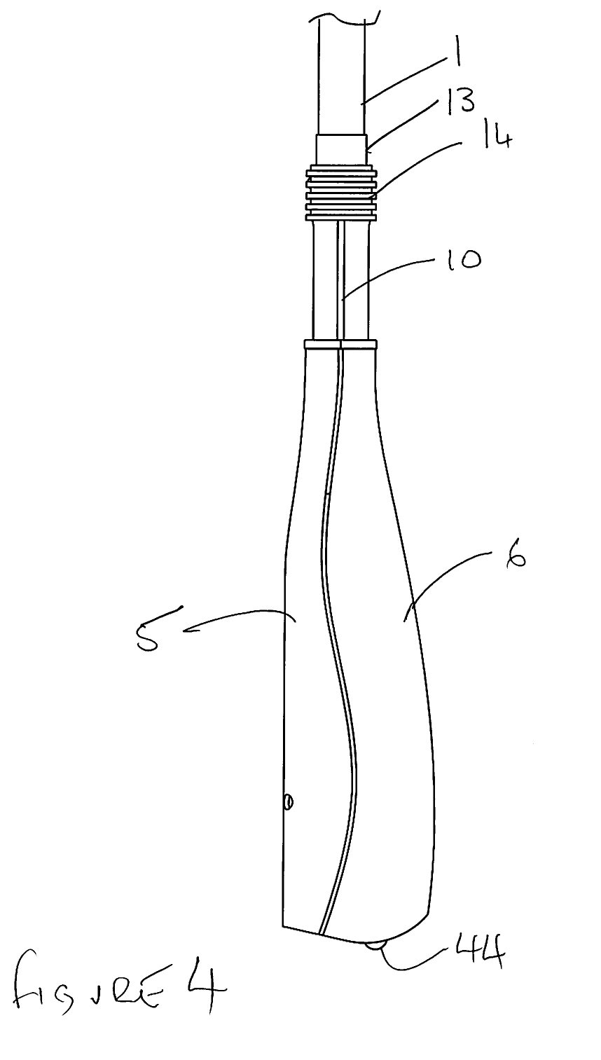

FIG. 5 is a central cross-sectional view on the line V-V of the brush head of FIG. 3;

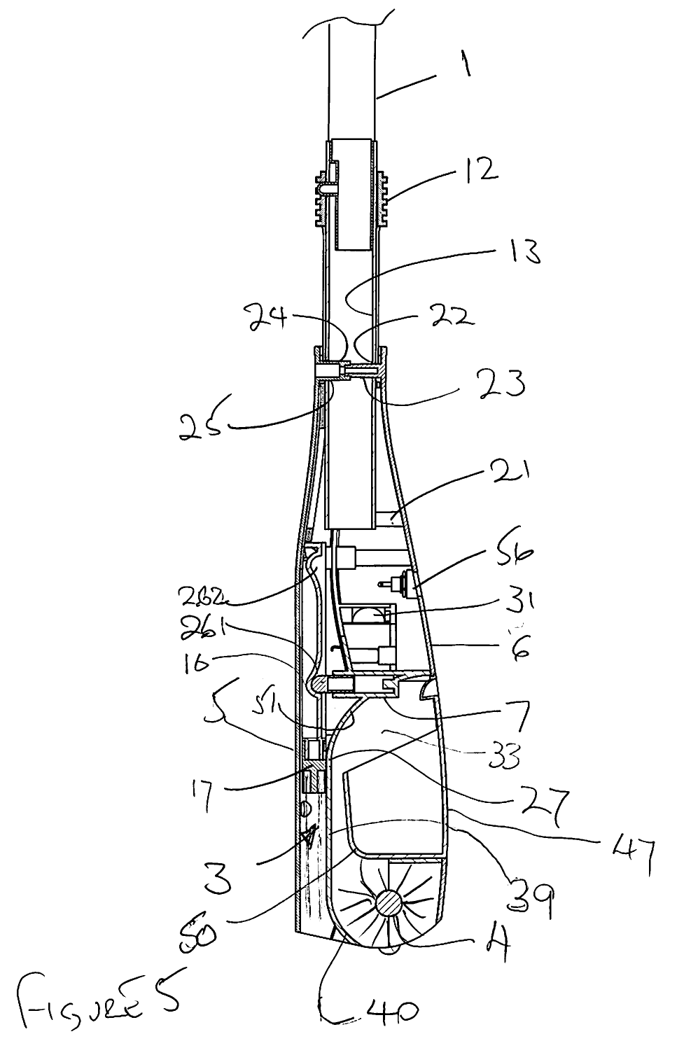

FIG. 6 is an upwards perspective view of the brush head with a front cover removed;

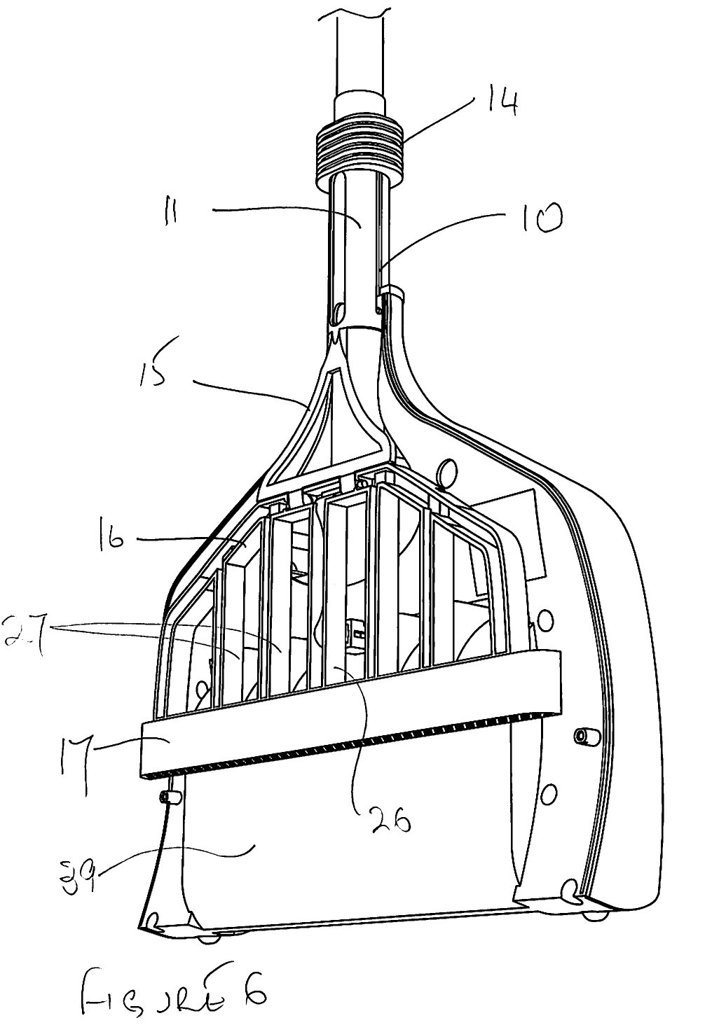

FIG. 7 is a view similar to FIG. 6 with bristles, broom and bristle supports removed;

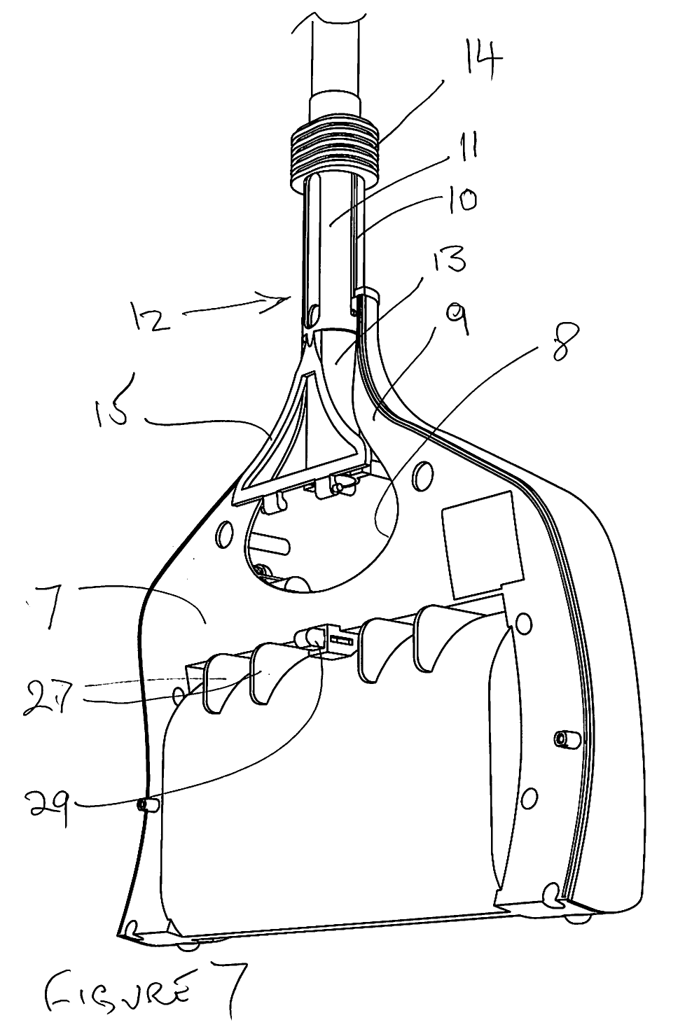

FIG. 8 is an inside view of the broom support;

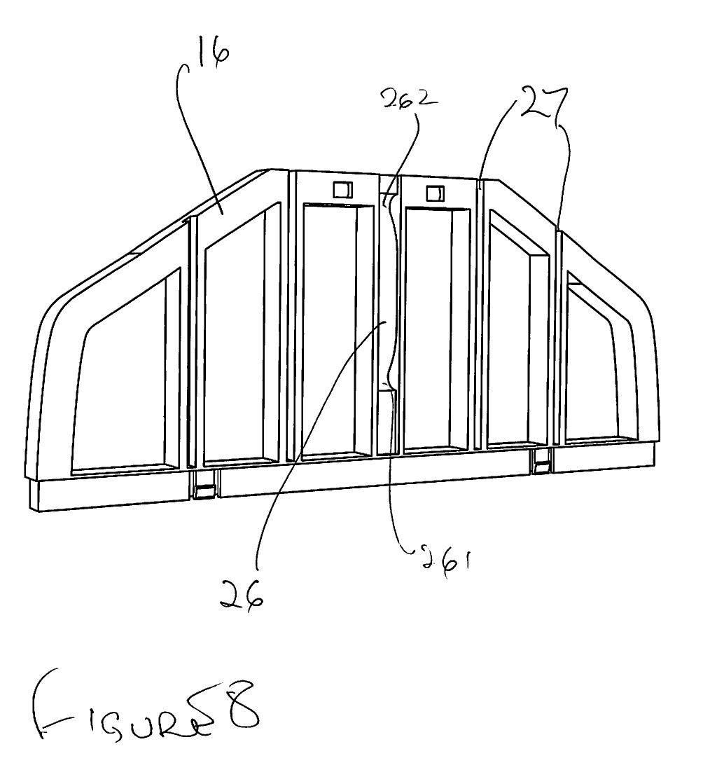

FIG. 9 is another upwards perspective view of the brush head with a rear cover and a dirt receptacle removed; and

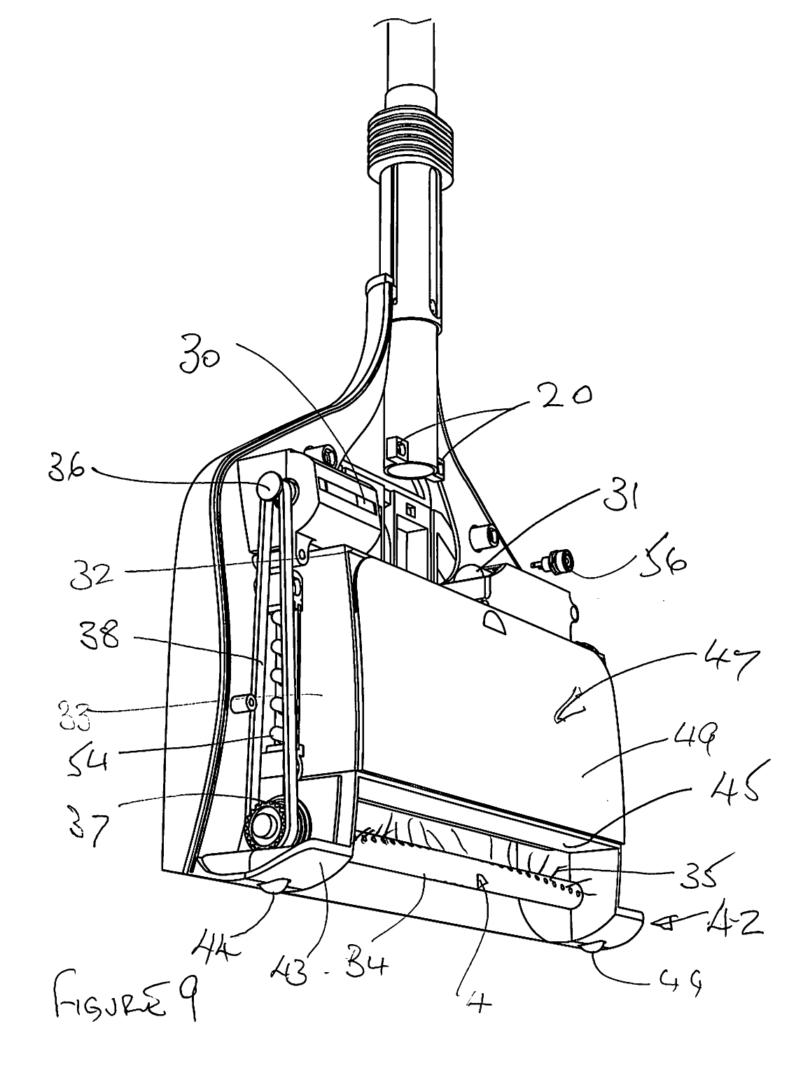

FIG. 10 is a central cross-sectional view similar to FIG. 5 on a larger scale showing a dirt path from a rotating brush to the dirt receptacle.

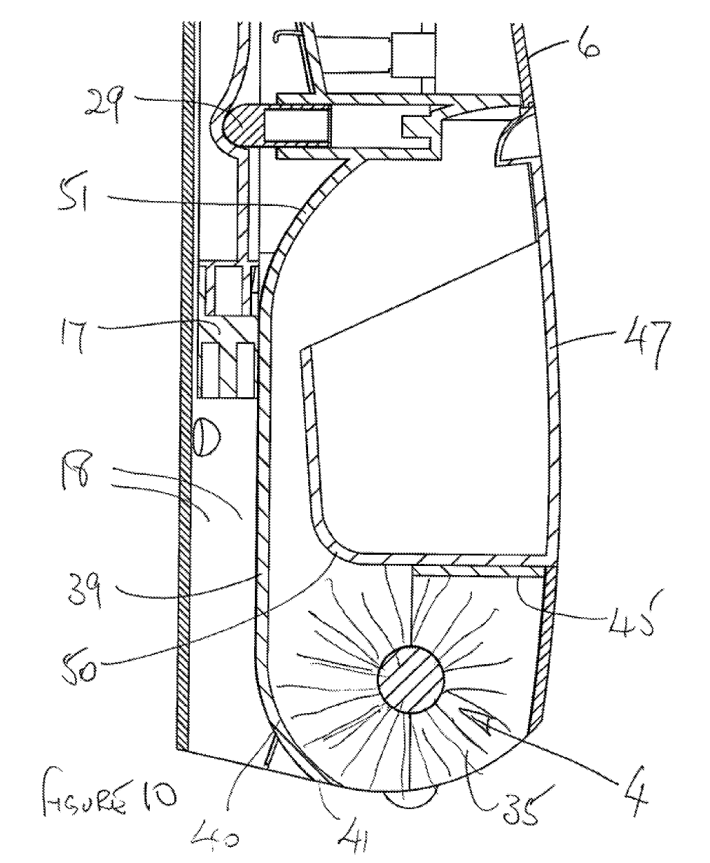

### DETAILED DESCRIPTION OF THE SEVERAL EMBODIMENTS

Referring to the drawings, the brushing device comprises a handle 1 with a brush head 2 at its lower, in use, end. The carrier carries a broom brush 3, which is extensible for sweeping dust, and a rotating brush 4 for picking up swept dust for delivery to a dust receptacle 47.

The carrier 2 is a three piece injection moulding, comprised of a front cover 5, a back cover 6 and a central moulding 7. The covers are connected to the central moulding and the each other by conveniently positioned screws in integrally moulded screw bosses that do not need to be separately described, but at least some of which can be seen on the drawings. The central moulding has an upwardly open void 8 between a pair of upwardly extend, converging fingers 9, which engage in slots 10 in a tubular part 11 of a broom brush extender 12. A handle socket 13 extends through the brush extender. For moving this, it is provided with a collar 14 at the top of the tubular part above the slots. The tubular part 11 ends below the slots, whereby the fingers 9 limit the extent of upwards and downwards movement of the broom brush extender. This has a further triangular extension 15 below the tubular part, which extension is arranged within the front cover 5, where it is connected to a broom support 16. It is to the bottom of this that a broom bristle support 17 is attached. Broom bristles 18 as such extend below the bristle support.

Movement of the collar 12 up and down the handle socket retracts and extends the bristles below the bottom 19 of the front cover and indeed the bottom of the central moulding.

It will be appreciated that the handle socket 13 requires firm anchoring with respect to the three piece injection moulding. For this, it has tabs 20, fixed by screws to bosses 21 provided on the inside of the back cover 6. Further, midway along the socket, it has an aperture 22 for another boss 23. A complementary boss 24 on the front cover passes through another bore 25. The two bosses are secured together with a screw, not shown.

The broom parts also require location. The broom support has five channel-form ribs, a central one 26 and four others 27. These others receive respective ears 28 extending from the central moulding into them. The other sides of the channels are supported by the front cover against moving out of engagement with the ears. Thus the broom support 16 is free to move only longitudinally of the channels. In a position corresponding to the ears, a spring loaded detent 29 is provided engaging in the central channel 26. It has two recesses 261,262 for the detent to engage in, for the withdrawn position of the broom and for its extended, use position. The bristle support 17 is arranged between the front cover and a divider 39 of the central moulding at all times, directing the bristles downwards and in particular below the bottom cover for use.

Within the back cover 6 there is mounted an electrical motor 30 and a battery pack 31 on a ledge 32 formed as part of the central moulding. Set back from the full width of the central moulding are a pair of flanges 33 extending down from the ledge. The rotating brush 4, in the form of a drum 34 with a helical arrangement of bristles 35, is journaled on them. A tooth pulleys 36, 37 and a toothed belt 38 are provided for transferring drive from the motor 30 to the rotating brush.

A divider 39 extends between the flanges. It is generally planar, except that its bottom edge is curved 40, with a lip 41 set just above the lower extent of the bristles 35, whereby most dirt engaged by the bristles is directed by the brush up the divider. The top of the divider curves over the rotating brush as it merges with ledge 32.

At the bottom of the flanges 33, a brush roller retainer 42 is provided. It has two ends 43 which also locate a pair of floor rollers 44. These determine the height of the lip 41 and the rotating brush 4 above a floor F. A strip 45 of the retainer extends above the rotating brush.

The back cover 6 holds the brush retainer in place. It has a rectangular aperture 46 for a dirt receptacle 47. This is removable and normally retained by a magnetic catch, not shown. It is a generally rectangular trough with a larger aperture closing front 49. Its bottom and inner back 50 are curved complementarily to the bottom of the central moulding 39, to provide a smooth path for picked up dirt. This is directed into the receptacle 47 by the top curvature 51 of the divider. The inner back 50 retains the dirt in the receptacle.

In use, dirt on the floor is swept with the downwards extended broom brush. The dirt is swept into a pile as with a conventional broom. The broom brush is then withdrawn and the motor switched on with a switch 52 at the top of the handle 1 plugged into the handle socket 11. Rolling the device over the pile of dirt causes the latter to be picked up by the rotating brush and deposited in the receptacle, which can be removed for emptying, as required.

LEDs 54 are provided down the outside of the flanges 33 to remind the user to turn the device off after use. A battery charging point 55 is provided, together with a charge indicator LED 56.

It will be appreciated the device allows the functions of a broom and a dustpan-and-brush to be performed with the one device, without the need to stoop to use a dustpan.

The invention is not intended to be restricted to the details of the above described embodiment, for instance the rotating brush could have its bristles replaced by blades, partially or completely.

What is claimed is:

1. A brushing device for brushing and picking up dirt, comprising:
a handle and
a brush head attached to the handle in use and carrying:
a broom brush for sweeping up dust,
a rotatable brush for picking up swept dust,
a motor for driving the rotatable brush and
a dust receptacle for receiving picked up dust.

2. A brushing device according to claim 1, wherein the broom brush is mounted to be permanently exposed, at least at one side, of the brush head for sweeping use.

3. A brushing device according to claim 1, wherein the broom brush is moveably mounted with respect to the brush head to be withdrawal into it.

4. A brushing device according to claim 3, wherein, for extension and withdrawal of the broom brush, it is connected to a grip movable axially of the handle.

5. A brushing device according to claim 4, wherein the grip is a collar provided around a socket for the handle.

6. A brushing device according to claim 3, wherein for accommodation of the bristles of the broom brush within the brush head when withdrawn, the brush head has a central partition and a front cover held spaced apart from each other for accommodating the broom brush.

7. A brushing device according to claim 1, wherein
the dirt receptacle is above the rotatable brush, in its use orientation, and
the arrangement is such that dirt from the rotating brush is projected against the broom brush for direction into the receptacle.

8. A brushing device according to claim 1, wherein
the dirt receptacle is above the rotatable brush, in its use orientation, and
the arrangement is such that dirt from the rotating brush is projected against the central partition for direction into the receptacle.

9. A brushing device according to claim 8, wherein the central partition has an over-hang for turning the dirt path to fall into the receptacle.

10. A brushing device according to claim 8, wherein a lower portion of the central partition is curved complementarily with an axis of rotation of the rotating brush.

11. A brushing device according to claim 10, wherein an opposite side of a dirt path is also be curved, with the opposite side preferably being provided on the receptacle.

12. A brushing device according to claim 6, wherein the brush head is a three piece injection moulding, comprised of a front cover, a back cover and a central moulding embodying the central partition.

13. A brushing device according to claim 12, wherein the central moulding has an upwardly open void between a pair of upwardly extend, converging fingers, which engage in slots in a tubular part of a broom brush extender.

14. A brushing device according to claim 13, wherein
a handle socket extends through the broom brush extender, which for its movement is provided with a collar at the top of the tubular part above the slots,
the tubular part ends below the slots, whereby the fingers limit the extent of upwards and downwards movement of the broom brush extender.

15. A brushing device according to claim 12, wherein
a broom support is attached below the broom brush extender and has
a plurality of five channel-form ribs, a central one and other outer ones,
respective ears receiving the outer ribs extend from the central moulding into them and
other sides of the channels are supported by the front cover against moving out of engagement with the ears.

16. A brushing device according to claim 12, wherein
the motor is an electrical motor and a battery pack mounted within the back cover on a ledge formed as part of the central moulding,
the rotating brush is in the form of a drum journaled at the bottom of the central moulding, preferably together with a pair of floor rollers and
a toothed belt is provided for transferring drive from the motor to the rotating brush.

17. A brushing device according to claim 12, wherein the back cover has an aperture for the dirt receptacle, which is removable and normally retained by a magnetic catch.
